(19) United States
(12) Patent Application Publication
(10) Pub. No.: US 2017/0268972 A1
(43) Pub. Date: Sep. 21, 2017

(54) Lateral Expansion Apparatus for Mechanical Testing of Stretchable Electronics

(71) Applicant: Intel Corporation, Santa Clara, CA (US)

(72) Inventors: Vijay Krishnan SUBRAMANIAN, Gilbert, AZ (US); Steven A. KLEIN, Chandler, AZ (US); Rajendra C. DIAS, Phoenix, AZ (US); Pramod MALATKAR, Chandler, AZ (US); Aleksandar ALEKSOV, Chandler, AZ (US); Ravindranath V. MAHAJAN, Chandler, AZ (US); Robert L. SANKMAN, Phoenix, AZ (US)

(21) Appl. No.: 15/075,090

(22) Filed: Mar. 18, 2016

(51) Int. Cl. G01N 3/08

(52) U.S. Cl. CPC G01N 3/08

(57) ABSTRACT

Embodiments are generally directed to a lateral expansion apparatus for mechanical testing of stretchable electronics. An embodiment of a system includes a compressible cylinder to apply mechanical forces to a stretchable electronics device by the compression and release of the compressible cylinder; a compression unit to compress to the compressible cylinder, wherein the compression unit is to apply a compression force in a direction along an axis of the compressible cylinder to generate lateral expansion of the compressible cylinder; and a testing logic to control compression and release of the compressible cylinder.

### TECHNICAL FIELD

Embodiments described herein generally relate to the field of electronic devices and, more particularly, to a lateral expansion apparatus for mechanical testing of stretchable electronics.

### BACKGROUND

Stretchable electronics, in which electronic circuits are deposited on stretchable substrates or embedded in stretchable materials, have the potential to be utilized in many new types of devices, including wearable devices and other implementations.

The stretching of stretchable electronics will inevitably stress the electronic elements to some degree, and may be cause failure over time. As new uses for stretchable electronics are being developed, it is becoming increasing important to provide repeatable testing of the stretchable electronics under appropriate conditions in order to fully understand the mechanical capability and reliability risks for stretchable electronic devices.

However, testing of stretchable electronics is generally not standardized, and thus it is difficult to properly evaluate materials and devices that contain stretchable electronics.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is an illustration of a stretchable electronics testing system utilizing lateral expansion operation according to an embodiment;

FIG. 2A is an illustration of a stretchable electronics testing system including a compressible cylinder with no compression force applied according to an embodiment;

FIG. 2B is an illustration of a stretchable electronics testing system including a compressible cylinder with compression force applied according to an embodiment;

FIG. 3 is an illustration of electrical testing provided in conjunction with mechanical testing of stretchable electronics according to an embodiment;

FIG. 4 is an illustration of a measurement of mechanical forces applied to stretchable electronics in a mechanical test utilizing lateral expansion according to an embodiment;

FIG. 5 is an illustration of test settings for a mechanical test of stretchable electronics according to an embodiment; and

FIG. 6 is a flowchart to illustrate lateral expansion based mechanical testing of stretchable electronics according to an embodiment.

### DETAILED DESCRIPTION

Embodiments described herein are generally directed to a lateral expansion apparatus for mechanical testing of stretchable electronics.

For the purposes of this description:

“Stretchable electronics” or “elastic electronics” means electronic circuits that are deposited on stretchable substrates or embedded into stretchable materials, wherein the stretchable substrates and stretchable materials may include, but are not limited to, silicones, polyurethanes, and polymers. The electronic circuits may include stretchable electronic devices. Stretchable electronics may include, but are not limited to, circuits embedded in wearable devices.

“Wearable device”, “wearable electronic device”, or “wearable” refers in general to clothing and accessories that incorporate electronic devices. A wearable device may include stretchable electronics.

In some embodiments, an apparatus, system, or method provides for mechanical testing of a stretchable electronics, in which mechanical forces are applied to a device under test to evaluate whether one or more failure conditions occur. In some embodiments, an apparatus, system, or method provides for a mechanical testing standard for stretchable electronics utilizing a lateral expansion apparatus. In some embodiments, a lateral expansion testing apparatus includes a compressible cylinder to apply mechanical forces on one or more stretchable electronics devices through the compression of the compressible cylinder causing a lateral expansion of the cylinder. The compressible cylinder is constructed with a compressible material, which may include, but is not limited to, rubber material.

In some embodiments, one or more stretchable electronics devices are attached to a compressible cylinder. In some embodiments, the cylinder is compressed by the application of force in a first direction, where the application of force may include use of a load frame or other method. During the compression of the cylinder, the cylinder will expand in a second direction, causing deformation of the attached samples. This process achieves a lateral expansion or stretching of the samples which is repeatable and cyclical. In some embodiments, failure monitoring, such as electrical testing of the devices under test, provides for device failure detection and mechanical capability of the wearable device predicted.

In some embodiments, the lateral expansion allows simulation of the expansion of the stretchable electronics devices in a similar way as would occur on the human body. This may provide a more realistic estimate of the type of mechanical damage that may occur to the samples in use. Further, this simulation may be applied to multiple stretchable electronics devices simultaneously as the shape of a compressible cylinder allows the application of mechanical forces to such devices in a combined test.

During compression, a force, F, is applied to the compressible cylinder, which results in lateral expansion of the compressible cylinder and in the lateral stretching of the samples. In some embodiments, the attachment of a stretchable electronics device may be adjusted such that the deformation induced is similar to the deformation which would occur during the use of an actual product (including, for example, an arm band, a wrist band, or other device).

In some embodiments, mechanical testing includes multiple compression and release cycles to provide repeated forces on the device under test. Further, because of the rapid expansion of a compressible cylinder under pressure and the rapid return of the compressible cylinder to its original shape after the release of pressure, the testing process is particularly well suited to mechanical testing requiring a large number of expansions and contractions, including rapid expansions and contractions.

In some embodiments, the testing further includes the addition of one or more environmental factors, such as temperature, humidity, and salinity (salt water testing to simulate sweat), to simulate conditions for the device under test in use, including use when in contact with or near to human skin. In some embodiments, the mechanical testing may include testing within a chamber, where, for example, temperature and other conditions may be adjusted to mimic use conditions and for accelerated temperature cycling testing. In some embodiments, the conditions being mimicked may include conditions for a patch that is on a human body, conditions for a bracelet or other wearable under daily temperature changes, and other such conditions.

In some embodiments, an apparatus or system includes electrical monitoring in-situ. In contrast to typical tensile testing of samples in lab scenarios, which may determine where bulk fracture occurs, electrical monitoring allows for detection of, for example, electrical opens in the traces of a device. In some embodiments, an apparatus or system is further operable to provide cyclic testing, which can detect types of damage to the device that are different than, for example, stretching a device sample to failure.

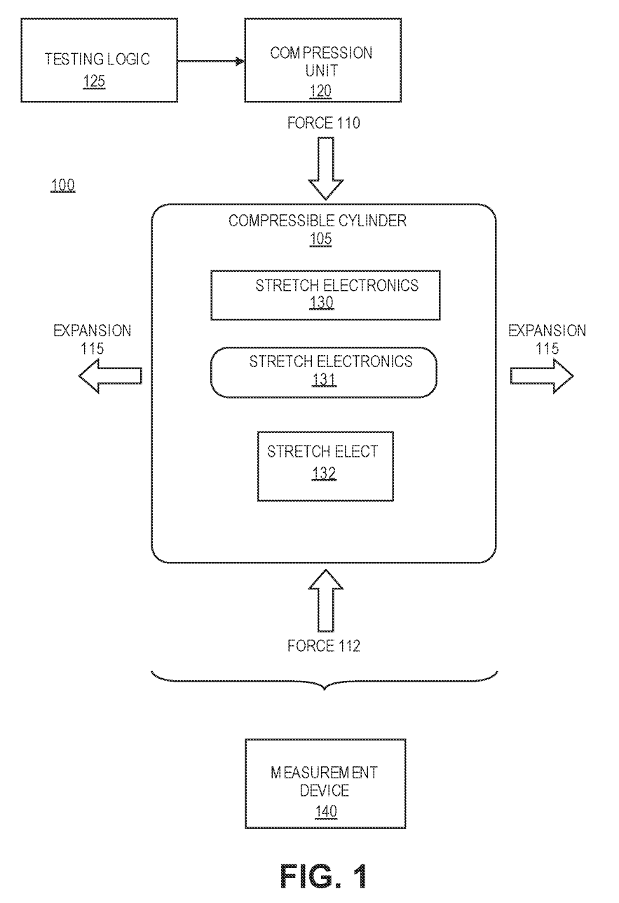

FIG. 1 is an illustration of a stretchable electronics testing system providing lateral expansion testing with a compressible cylinder according to an embodiment. In the high level diagram provided in FIG. 1, a testing system 100 includes a compressible cylinder, to which may be attached multiple stretchable electronics devices under test (DUTs) 130, 131, and 132, wherein the devices under test are attached to the compressible cylinder to apply mechanical force to the stretchable electronics of the devices under test 130-132 as the compressible cylinder is compressed and released. As illustrated, the devices under test 130-132 may vary in shape and size

In some embodiments, the mechanical testing system 100 includes the application of one or more forces 110 and 112 along an axis of the compressible cylinder 105 to cause lateral expansion 115 of the cylinder 105 and thus the application of force to the devices under test 130-131. Application of force may include a force applied in one direction and a solid surface to hold the cylinder in place, or may include opposite forces being applied at a same time. In a particular implementation, a compression unit 120 generates the one or more forces 110-112, where the compression unit 120 is controlled by testing logic 125. The testing logic 125 may include, but is not limited to, a computing system running a testing platform with control software.

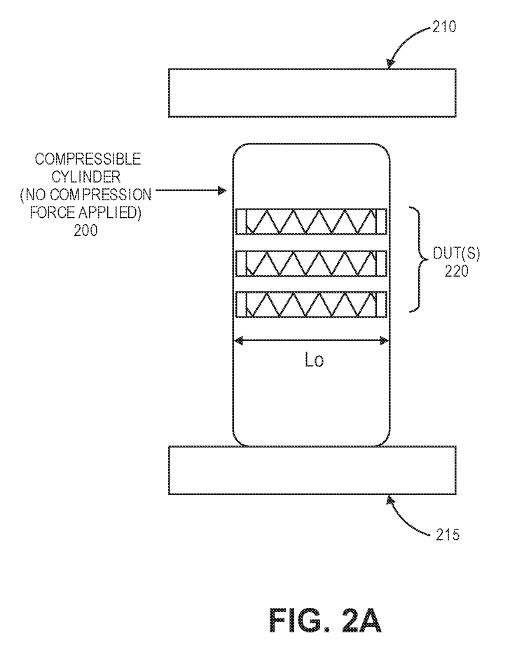

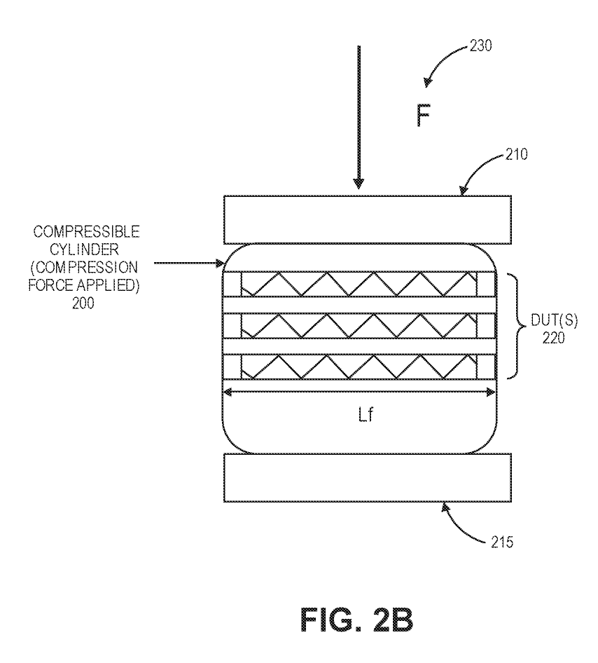

FIGS. 2A and 2B are illustrations of stretchable electronics testing system including lateral forces generated by a compressible cylinder according to an embodiment.

FIG. 2A is an illustration of a stretchable electronics testing system including a compressible cylinder with no compression force applied according to an embodiment. As illustrated, multiple devices under test 220 are attached to the cylinder 200, with initial width (diameter) of the cylinder being Lo.

As illustrated, the cylinder 200 may be coupled with a first surface 215 of a load frame or similar device to hold the cylinder in place, while a second surface 210 of the load frame or similar device is to apply compression force to the cylinder 200 in a first direction along an axis of the cylinder 200. In general the first surface 215 and the second surface are parallel to each other in order to provide a uniform compression force on the cylinder 200.

FIG. 2B is an illustration of a stretchable electronics testing system including a compressible cylinder with compression force applied according to an embodiment. FIG. 2B illustrates the compressible cylinder 200 with a compression force 230 applied via the second surface 210, thus generating a lateral expansion of the cylinder to a diameter of Lf. As illustrated, the multiple devices under test 220 attached to the cylinder 200 are stretched together with the lateral expansion of the cylinder.

In some embodiments, cyclic testing of the devices under test 220 includes repeated cycles of the application and release of the force 230, thus resulting in the repeated application and release of mechanical forces on the devices under test, which may occur rapidly if required.

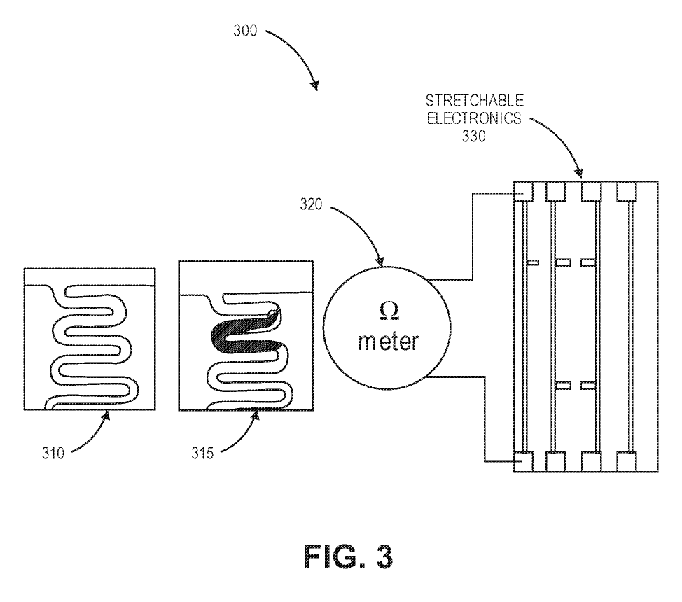

FIG. 3 is an illustration of electrical testing provided in conjunction with mechanical testing of stretchable electronics according to an embodiment. In some embodiments, a test operation 300 for stretchable electronics 330, such as the devices under test 130-132 illustrated in FIG. 1 or the devices under test 220 illustrated in FIGS. 2A and 2B, includes, but is not limited to, testing of one or more electrical values for the stretchable electronics 330 as the electronics are subjected to mechanical force, such as mechanical force induced by the compression and release of the compressible cylinder 105 illustrated in FIG. 1 or the compressible cylinder 200 illustrated in FIGS. 2A and 2B. The electrical testing is provided to determine onset of failure of the stretchable electronics as a result of the mechanical force applied by the testing. The electrical testing may include, but is not limited to, measurement of resistance change. In some embodiments, the electrical testing may be combined with the mechanical testing illustrated in FIGS. 1, 2A, and 2B.

In a particular implementation, the mechanical testing of stretchable electronics may affect a trace section 310 such that a least a portion of the trace section lifts away 315. Because of this affect, the electrical resistance of the trace may change, wherein the change may result in an infinite resistance at an extreme but also result in simply a higher than normal resistance in other cases. Further, in additional to any permanent change in resistance, a temporary or sporadic change may occur, such as only while a force is applied to the stretchable electronics 330. In some embodiments, the testing may include application of an ohmmeter to measure resistance, where such measurement may be made constantly or at certain sample points to allow detection of temporary or sporadic changes in resistance.

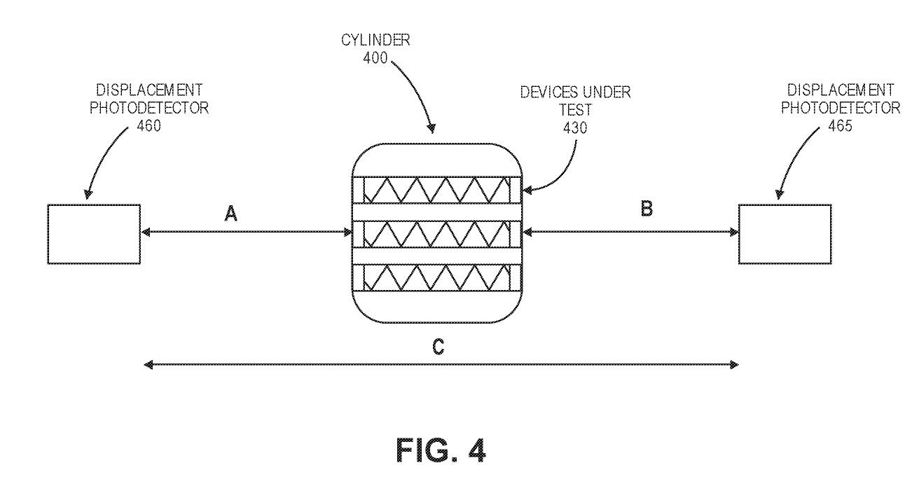

FIG. 4 is an illustration of a measurement of mechanical force applied to stretchable electronics in a mechanical test according to an embodiment. In some embodiments, a compressible cylinder 400 is utilized in mechanical testing of a stretchable electronics device under test 430, including, for example testing in a system as illustrated in FIG. 1 or FIGS. 2A and 2B. In some embodiments, the mechanical force applied to the electronics of the device under test 430 may be determined by one or more monitoring units. In some embodiments, mechanical force may be determined by measuring a change in lateral size of the compressible cylinder, such as force being determined as a function of a difference between a diameter of the cylinder 400 at a first time no compression force is applied to the cylinder and no mechanical force is applied to the devices under test 430, and the diameter at a second time in which a compression force is applied to the cylinder 400. In this example, the length of the stretchable electronics increases linearly with the circumference of the cylinder, or 7C times the diameter of the cylinder.

In some embodiments, the diameter (or other physical measurement) of the cylinder 400 is determined automatically, such as an automatic determination based on light reflection time utilizing one or more displacement photodetectors. In the illustrated implementation, a diameter of the cylinder is equal to a distance C between a first displacement photodetector 460 and a second displacement photodetector 465, minus a first distance A between the first displacement photodetector 460 a first side of the cylinder and minus a second distance B between the second displacement photodetector 465 and a second, opposite side of the cylinder 400. As a equation:

Diameter=C−A−B [1]

FIG. 4 provides a particular measurement system, but embodiments are not limited to this particular implementation. In some embodiments, measurement of mechanical force may include alternative measurement technologies, including, but not limited to, the following:

(1) A strain gauge may be employed around or integrated into the compressible cylinder. The strain gauge changes, for example, electrical resistance in a pre-determined way with applied strain and thus the diameter change of the cylinder can be determined from measurements of the strain gauge.

(2) Digital image correlation may be utilized, wherein a camera and lens system tracks the displacement or strain of the sample in a non-contact manner. The digital image correlation may be utilized to provide real time measurement of mechanical force applied to the device under test.

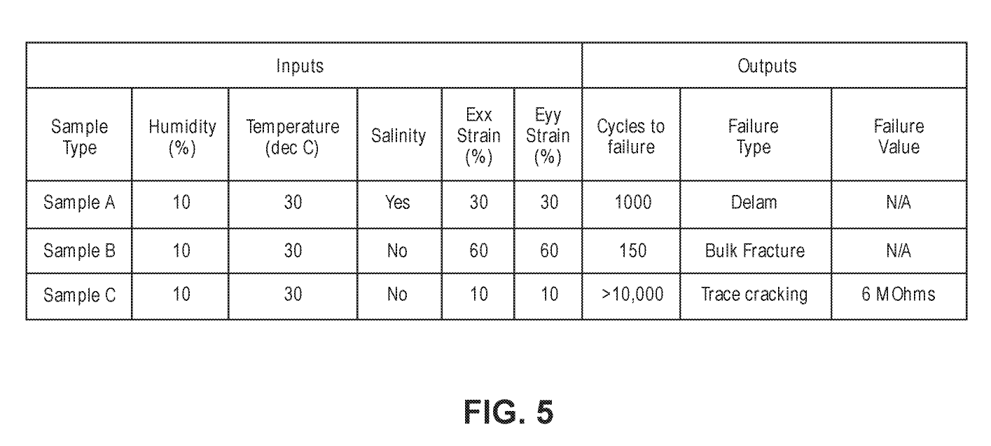

FIG. 5 is an illustration of test settings for a mechanical test of stretchable electronics according to an embodiment. In some embodiments, the testing may include testing using the system illustrated in FIG. 1 or as illustrated in FIGS. 2A and 2B. While particular examples of testing for three samples are illustrated in FIG. 5, embodiments are not limited to the illustrated inputs and outputs, or to particular settings for each test.

In some embodiments, testing inputs for each of a plurality of samples may include, but are not limited to, a humidity level (as a percentage); a temperature level (as degrees Celsius); salinity (such as whether a certain amount of salt is or is not added); strain in a first direction (such as in terms of a percentage of a length in a first direction, E_{XX} strain) and strain in a second direction (such as in terms of a percentage of a length in a second direction, E_{YY} strain). Strain may also be measured directly using a strain gauge.

Other examples include ultraviolet testing to determine effect on cyclic testing, or damage resulting as a result from extended time at a set strain value (with humidity and temperature as variables as well).

In some embodiments, testing outputs for each of a plurality of samples may include a number of cycles to failure (such as a certain number of compression and release cycles for a particular set of test input settings); a particular failure type (such as, for example, delamination of the stretchable electronics occurring within a certain number of cycles; bulk fracture of stretchable electronics occurring within a certain number of cycles; or trace cracking within any number of cycles); and a failure value (such as a certain electrical resistance value that is indicative of a trace cracking condition).

In some embodiments, the detection of a failure condition may include, but is not limited to, the following:

(1) Trace (metal) cracking: Trace cracking may be determined with an electrical resistance test, as resistance is expected to change as traces are damaged. In some embodiments, trace cracking may also include more complicated electrical testing, such as parametric testing and functional testing of stretchable electronics.

(2) Delamination: In some embodiments, for optically transparent materials testing for delamination may include can use optical imaging or photoelastic testing processes. In some embodiments, for non-transparent materials, delamination may detected using, for example, an acoustic sensor to identify areas of delamination

(3) Bulk fracture: In some embodiments, bulk fracture testing may utilize electrical testing, such as described stated above. In some embodiments, bulk fracture may also be detected utilizing a contact sensor (load cell/contact pressure sensor), which can determine if a sample is still in contact with the compressible cylinder.

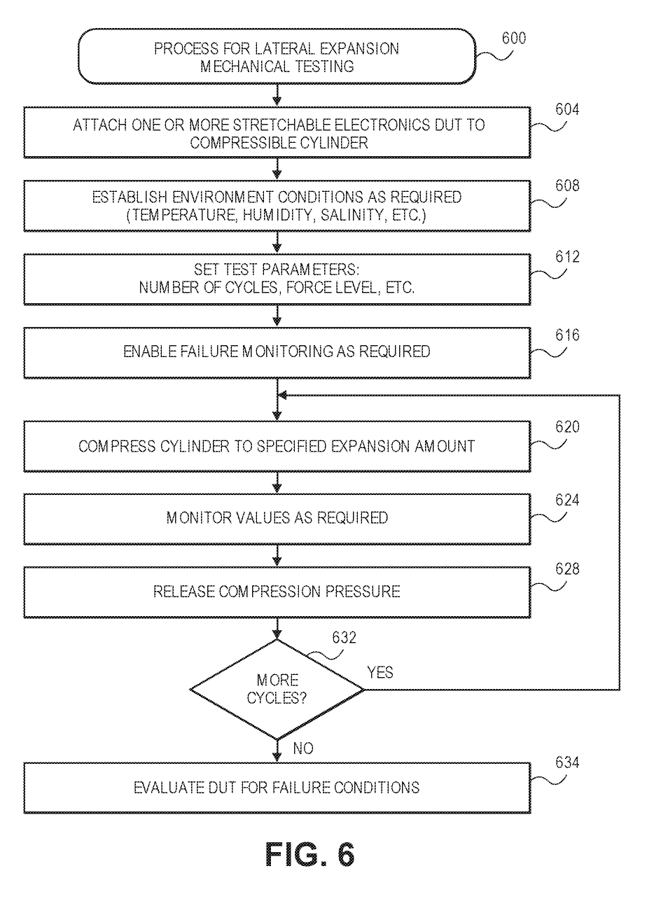

FIG. 6 is a flowchart to illustrate lateral expansion based mechanical testing of stretchable electronics according to an embodiment. In some embodiments, a process 600 for lateral expansion based mechanical testing of stretchable electronics includes:

604: Attach one or more stretchable electronics devices under test (DUTs) to compressible cylinder of a testing system.

608: Establish environmental conditions as required for the mechanical testing, which includes, but is not limited to, establishing required conditions for temperature, humidity, and salinity, such as illustrated in FIG. 5.

612: Set test parameters, where such test parameters may include, but are not limited to, number of compression and release cycles for the compressible cylinder, and mechanical force level.

616: Enable failure monitoring as required for testing, including, but not limited to, electrical testing providing monitoring of electrical conditions of the stretchable electronics during testing (such as monitoring a resistance utilizing an ohmmeter or measure any other electrical value of the stretchable electronics); strain gauge monitoring; or digital image correlation.

620: Commence a first cycle by compressing the compressible cylinder to a particular level to generate a certain mechanical force level. A determination of the mechanical force level may include, but is not limited to, compressible cylinder measurement as illustrated in FIG. 5.

624: Monitor values for the stretchable electronics as required, such as a measurement as illustrated in FIG. 5.

628: Complete an compression-release cycle by releasing the compression force on the compressible cylinder after a certain amount of time;

632: Determine whether there are additional cycles to be performed in the particular test. If so, the process returns to compressing the compressible cylinder to perform another cycle.

634: If not, the testing cycles are complete, and the process may continue with evaluating the stretchable electronics device under test to determine whether there is any failure of the device, such as by delamination, trace crack, or bulk fracture of the stretchable electronics.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, compact disk read-only memory (CD-ROM), and magneto-optical disks, read-only memory (ROM), random access memory (RAM), erasable programmable read-only memory (EPROM), electrically-erasable programmable read-only memory (EEPROM), magnet or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

In some embodiments, a mechanical testing system includes: a compressible cylinder to apply mechanical forces to a stretchable electronics device by the compression and release of the compressible cylinder; a compression unit to compress to the compressible cylinder, wherein the compression unit is to apply a compression force in a direction along an axis of the compressible cylinder to generate lateral expansion of the compressible cylinder; and a testing logic to control compression and release of the compressible cylinder.

In some embodiments, the system further includes a monitoring unit to monitor for a failure condition in the stretchable electronics device.

In some embodiments, the monitoring unit is to detect an electrical value of the stretchable electronics device. In some embodiments, the electrical value is an electrical resistance value.

In some embodiments, the system further includes a measurement unit to measure mechanical force on the stretchable electronics device. In some embodiments, the measurement unit is to measure a change in size of the compressible cylinder by the lateral expansion of the compressible cylinder. In some embodiments, the measurement includes one or more photodetectors to detect one or more distances relating to the compressible cylinder.

In some embodiments, the control unit includes a computer with control software.

In some embodiments, system further includes a chamber to provide control of environmental conditions for the stretchable electronics.

In some embodiments, the compression unit includes a load frame to provide the compression force.

In some embodiments, the compressible cylinder is composed of rubber.

In some embodiments, a method includes receiving test parameters for mechanical testing of a stretchable electronics device, the stretchable electronics device being coupled with a compressible cylinder, the test parameters including a specified level of mechanical force to be applied to the stretchable electronics device; performing one or more compression and release cycles for the compressible cylinder based at least part on the test parameters, including compressing the compressible cylinder to the specified level of mechanical force; and monitoring for one or more failure conditions for the stretchable electronics device.

In some embodiments, the mechanical forces include one or more of stress, strain, or displacement.

In some embodiments, the test parameters further include a specified number of compression and release cycles for testing of the stretchable electronics device.

In some embodiments, monitoring for one or more failure conditions includes monitoring one or more electrical values of the stretchable electronics device. In some embodiments, the one or more electrical values of the stretchable electronics device include an electrical resistance of the stretchable electronics device.

In some embodiments, the method further includes applying one or more environmental conditions for the mechanical testing of the stretchable electronics.

In some embodiments, the one or more environmental conditions include one or more of temperature, humidity, and salinity.

In some embodiments, the one or more failure conditions include one or more of: trace cracking of the stretchable electronics device; delamination of the stretchable electronics device; or bulk fracture of the stretchable electronics device.

In some embodiments, a non-transitory computer-readable storage medium having stored thereon data representing sequences of instructions that, when executed by a processor, cause the processor to perform operations including receiving test parameters for mechanical testing of a stretchable electronics device, the stretchable electronics device being coupled with a compressible cylinder, the test parameters including a specified level of mechanical force to be applied to the stretchable electronics device; performing one or more compression and release cycles for the compression and release based at least part on the test parameters, including compressing the compressible cylinder to the specified level of mechanical force; and monitoring for one or more failure conditions for the stretchable electronics device.

In some embodiments, an apparatus includes means for receiving test parameters for mechanical testing of a stretchable electronics device, the stretchable electronics device being coupled with a compressible cylinder, the test parameters including a specified level of mechanical force to be applied to the stretchable electronics device; means for performing one or more compression and release cycles for the compression and release based at least part on the test parameters, including compressing the compressible cylinder to the specified level of mechanical force; and means for monitoring for one or more failure conditions for the stretchable electronics device.

1. A mechanical testing system comprising:
a compressible cylinder to apply mechanical forces to a stretchable electronics device by the compression and release of the compressible cylinder;
a compression unit to compress to the compressible cylinder, wherein the compression unit is to apply a compression force in a direction along an axis of the compressible cylinder to generate lateral expansion of the compressible cylinder; and
a testing logic to control compression and release of the compressible cylinder.

2. The system of claim 1, further comprising a monitoring unit to monitor for a failure condition in the stretchable electronics device.

3. The system of claim 2, wherein the monitoring unit is to detect an electrical value of the stretchable electronics device.

4. The system of claim 3, wherein the electrical value is an electrical resistance value.

5. The system of claim 1, further comprising a measurement unit to measure mechanical force on the stretchable electronics device.

6. The system of claim 5, wherein the measurement unit is to measure a change in size of the compressible cylinder by the lateral expansion of the compressible cylinder.

7. The system of claim 6, wherein the measurement includes one or more photodetectors to detect one or more distances relating to the compressible cylinder.

8. The system of claim 1, wherein the control unit testing logic includes a computer with control software.

9. The system of claim 1, further comprising a chamber to provide control of environmental conditions for the stretchable electronics device.

10. The system of claim 1, wherein the compression unit includes a load frame to provide the compression force.

11. The system of claim 1, wherein the compressible cylinder is composed of rubber.

12. A method comprising:
receiving test parameters for mechanical testing of a stretchable electronics device, the stretchable electronics device being coupled with a compressible cylinder, the test parameters including a specified level of mechanical force to be applied to the stretchable electronics device;
performing one or more compression and release cycles for the compressible cylinder based at least part on the test parameters, including compressing the compressible cylinder to the specified level of mechanical force; and
monitoring for one or more failure conditions for the stretchable electronics device.

13. The method of claim 12, wherein the mechanical forces include one or more of stress, strain, or displacement.

14. The method of claim 12, wherein the test parameters further include a specified number of compression and release cycles for testing of the stretchable electronics device.

15. The method of claim 12, wherein monitoring for one or more failure conditions includes monitoring one or more electrical values of the stretchable electronics device.

16. The method of claim 15, wherein the one or more electrical values of the stretchable electronics device include an electrical resistance of the stretchable electronics device.

17. The method of claim 12, further comprising applying one or more environmental conditions for the mechanical testing of the stretchable electronics device.

18. The method of claim 17, wherein the one or more environmental conditions include one or more of temperature, humidity, and salinity.

19. The method of claim 12, wherein the one or more failure conditions include one or more of:
trace cracking of the stretchable electronics device;
delamination of the stretchable electronics device; or
bulk fracture of the stretchable electronics device.

20. A non-transitory computer-readable storage medium having stored thereon data representing sequences of instructions that, when executed by a processor, cause the processor to perform operations comprising:
receiving test parameters for mechanical testing of a stretchable electronics device, the stretchable electronics device being coupled with a compressible cylinder, the test parameters including a specified level of mechanical force to be applied to the stretchable electronics device;
performing one or more compression and release cycles for the compression and release based at least part on the test parameters, including compressing the compressible cylinder to the specified level of mechanical force; and
monitoring for one or more failure conditions for the stretchable electronics device.

21. The medium of claim 20, wherein monitoring for one or more failure conditions includes monitoring one or more electrical values of the stretchable electronics device.

22. The medium of claim 21, wherein the one or more electrical values of the stretchable electronics device include an electrical resistance of the stretchable electronics device.
